(19) United States
(12) Patent Application Publication
(10) Pub. No.: US 2003/0188587 A1
(43) Pub. Date: Oct. 9, 2003

(54) Sampling system for a separation channel

(76) Inventor: Andreas Manz, East Molesey (GB)

Correspondence Address: NIXON & VANDERHYE, PC, 1100 N GLEBE ROAD, 8TH FLOOR, ARLINGTON, VA, 22201-4714, US

(21) Appl. No.: 10/296,587

(22) PCT Filed: May 25, 2001
(86) PCT No.: PCT/GB01/02340

(30) Foreign Application Priority Data
May 26, 2000 (GB) 0012999.9

(51) Int. Cl. G01N 1/44; G01N 1/22; G01N 21/73

(52) U.S. Cl. 73/863.12; 422/83

(57) ABSTRACT

A sampling system for providing a sample plug 70 from a fluid sample, comprising: a flow channel through which a flow of a fluid sample is passed; plasma generators 12 and 14; and a control unit configured to drive the plasma generator 12 at a power level at which the fluid sample is modified by the plasma P1 and interrupt busy the plasma P1 for a period of time such as to allow a plug of the fluid sample to pass downstream thereof. The volume of the plug 70 is determined by the time period during which the plasma P1 is interrupted. With the plasma P1 being maintained, the components of the plug 70 separate on transit through a separation channel 10. These components pass through the second plasma P2, and the emissions generated are detected by an optical detector 16.

The present invention relates to a sampling system, preferably as a microfabricated chip-based unit, for and a method of providing a volume, as a sample plug, from a flow of a fluid sample, in particular a gaseous sample, and to a measurement system incorporating the sampling system.

Precisely metered volumes of fluid samples, typically very small volumes of up to 2 μl, are required by many measurement systems, such as gas chromatographs, for accurate sample analysis.

Microsyringes are commonly used to deliver metered volumes of fluid samples. These syringes, however, have a limited volumetric accuracy, and as such are not suited to the delivery of very small volumes.

Minaturized chip-based sampling systems have been proposed, but these systems are complex and require moving components to valve and meter a fluid sample. As will be appreciated, the fabrication of systems including such minaturized components is particularly difficult, and in requiring moving parts can suffer from problems of reliability.

It is thus an aim of the present invention to provide an improved sampling system for providing sample plugs of small volume from a flow of a fluid sample, and in particular a sampling system which requires no moving parts. It is also an aim of the present invention to provide an improved sampling method.

Accordingly, the present invention provides a sampling system for providing a volume, as a sample plug, from a flow of a fluid sample, comprising: a flow channel through which a flow of a fluid sample is in use passed; a plasma generator for generating a plasma in the flow channel; and a control unit operably configured to drive the plasma generator at a power level at which the fluid sample passing therethrough is modified by the plasma and interrupt the plasma for a predeterminable period of time such as to allow a sample plug of the fluid sample to pass downstream thereof.

Preferably, the control unit is configured to switch the plasma generator between a first power level at which the fluid sample is modified by the plasma and a second, lower power level.

More preferably, the fluid sample is substantially unmodified by the plasma at the second power level.

Still more preferably, the second power level is a zero power level at which the plasma generator is switched off.

Preferably, the control unit is configured to drive the plasma generator at a power at which the fluid sample is destroyed by the plasma.

In one embodiment the control unit can be configured to switch the plasma generator between three or more power levels.

Preferably, the plasma generator includes first and second electrodes across which a voltage is applied to generate the plasma.

The flow channel can be a substantially linear channel or a meandering channel which preferably includes a plurality of bends.

Preferably, the sampling system further comprises at least one further plasma generator upstream of the first-mentioned plasma generator, and wherein the control unit is operably configured to drive each of the plasma generators at a power level at which the fluid sample passing therethrough is modified by the respective plasma and interrupt the respective plasma for a predeterminable period of time.

Preferably, the sampling system further comprises a substrate chip in which the flow channel and the or each plasma generator are defined.

The present invention also extends to a measurement system comprising the above-described sampling system.

Preferably, the flow channel defines a separation channel downstream of the plasma generator in which the components of the sample plug are in use separated, and further comprising a detector downstream of the separation channel for detecting the separated components of the sample plug.

More preferably, the detector comprises a plasma generator for generating a detection plasma in the flow channel downstream of the separation channel and an optical sensor for detecting the optical emission of the detection plasma.

The present invention also provides a method of providing a volume, as a sample plug, from a flow of a fluid sample, comprising the steps of: providing a sampling system comprising a flow channel and a plasma generator for generating a plasma in the flow channel; passing a flow of a fluid sample through the flow channel; generating a plasma in the flow channel at a power level to modify the fluid sample passing therethrough; and interrupting the plasma for a predeterminable period of time such as to allow a sample plug of the fluid sample to pass downstream thereof.

Preferably, the step of interrupting the plasma comprises the step of switching the plasma generator to a second, lower power level.

More preferably, the fluid sample is substantially unmodified by the plasma at the second power level.

Still more preferably, the second power level is a zero power level at which the plasma generator is switched off.

Preferably, the fluid sample is destroyed by the plasma at the first power level.

In one embodiment the step of interrupting the plasma comprises the step of switching the plasma generator between three or more power levels.

Preferably, the plasma generator includes first and second electrodes across which a voltage is applied to generate the plasma.

The flow channel can be a substantially linear channel or a meandering channel which preferably includes a plurality of bends.

Preferably, the method further comprises the step of generating at least one further plasma upstream of the first-mentioned plasma at a power level to modify the fluid sample passing therethrough, and wherein the step of interrupting the plasma comprises the step of interrupting each of the respective plasmas for a predeterminable period of time.

Preferably, the sampling system further comprises a substrate chip in which the flow channel and the or each plasma generator are defined.

Preferably, the fluid sample is a gaseous sample. In this context the term gaseous sample is to be understood as encompassing gases and supercritical fluids.

A preferred embodiment of the present invention will now be described hereinbelow by way of example only with reference to the accompanying drawings, in which:

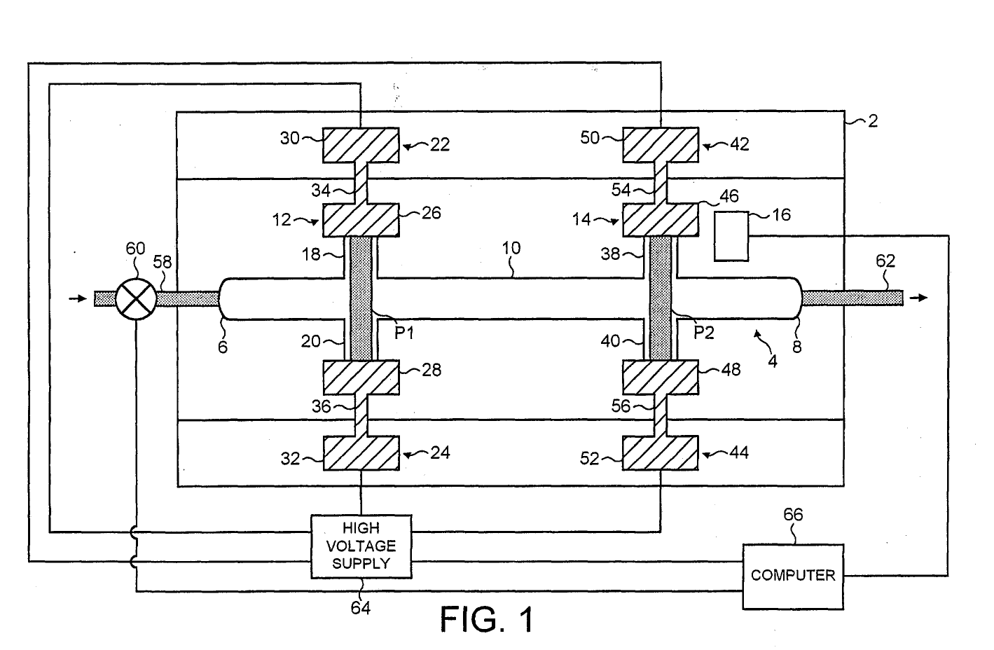

FIG. 1 schematically illustrates a microfabricated chip-based measurement system in accordance with a preferred embodiment of the present invention;

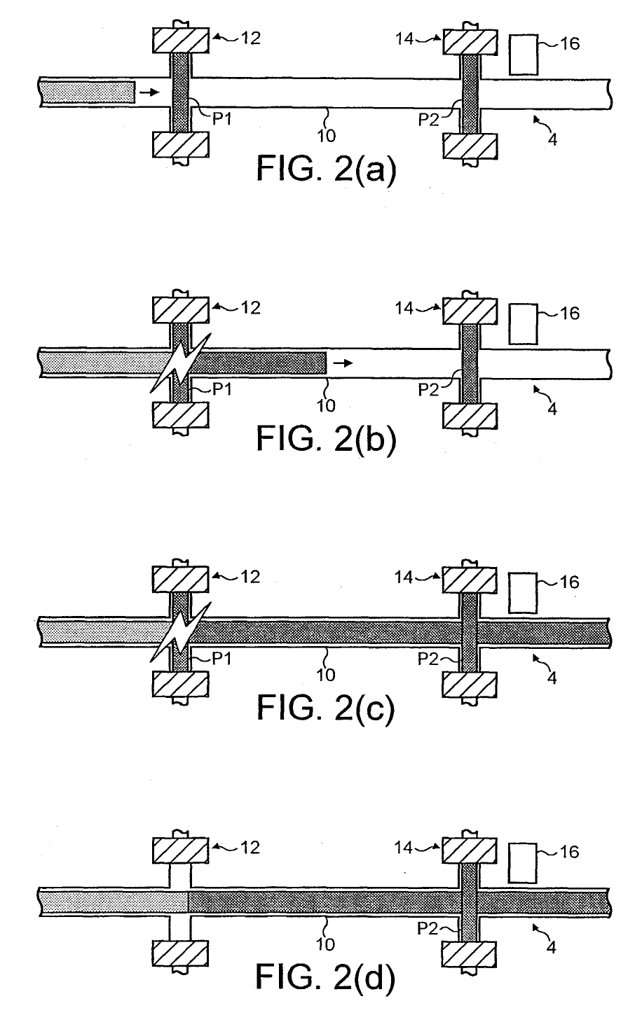

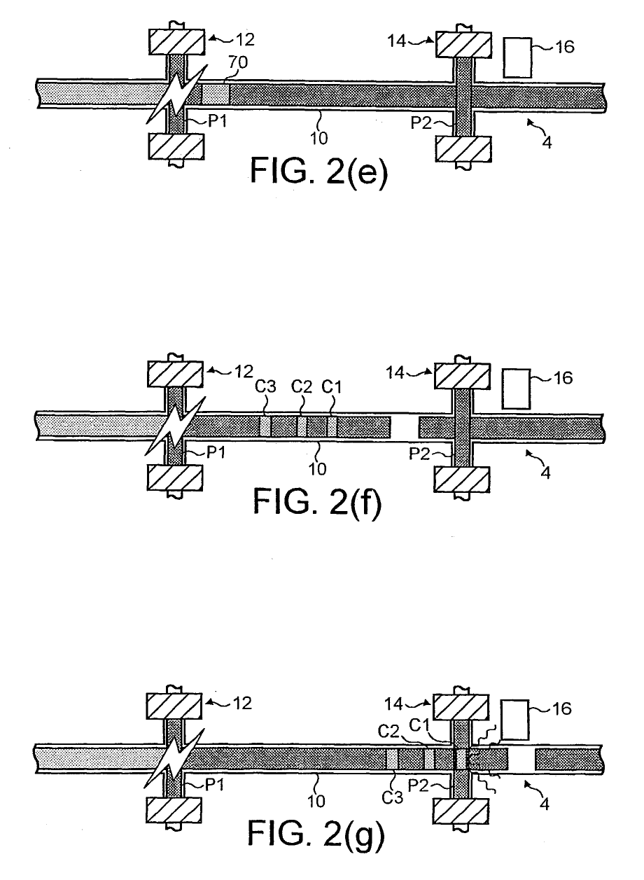

FIGS. 2(a) to (g) schematically illustrate the operation of the measurement system of FIG. 1;

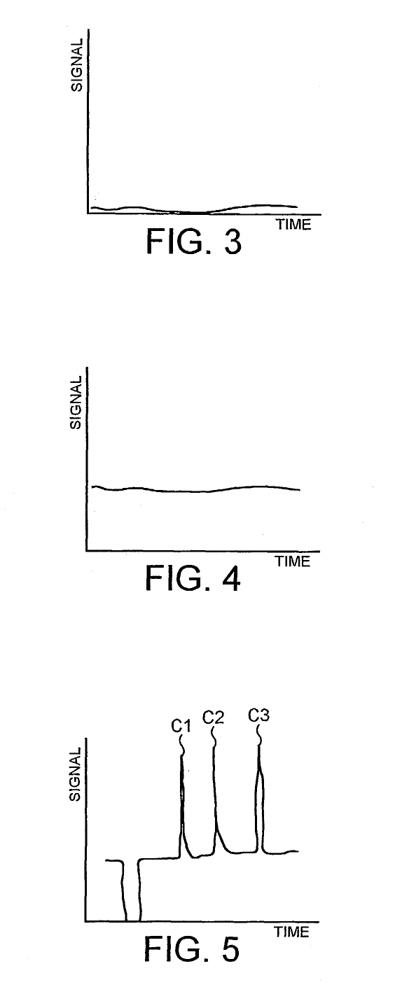

FIGS. 3 to 5 schematically illustrate spectra detected by the detector of the measurement system of FIG. 1; and

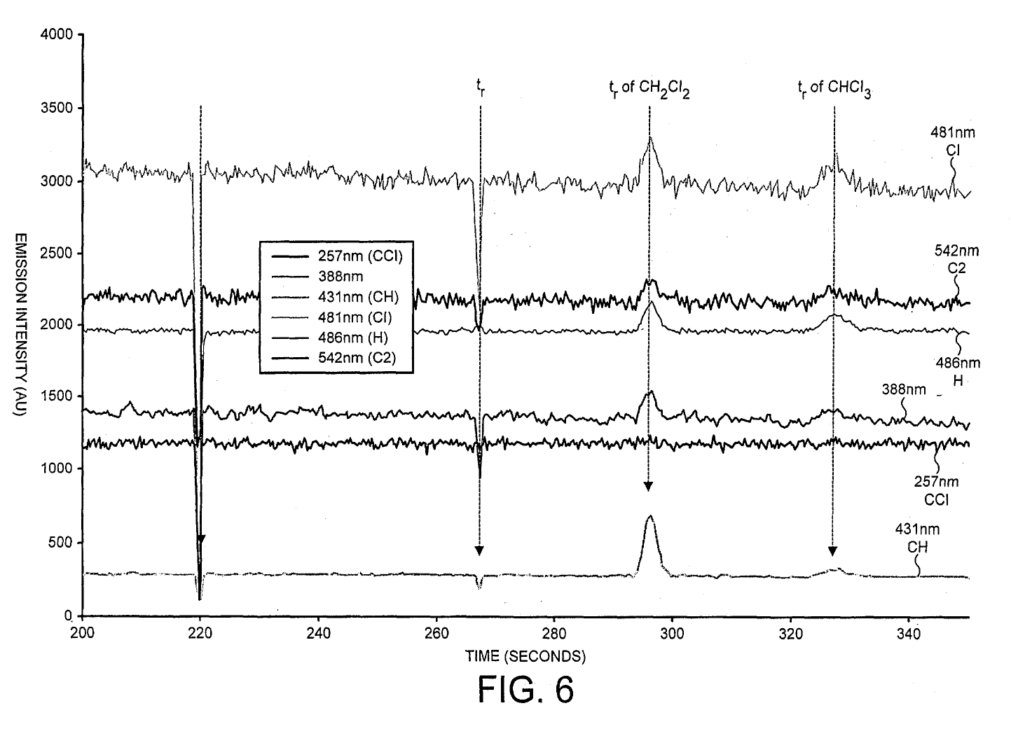

FIG. 6 illustrates further spectra detected when operating a system in accordance with any example embodiment.

FIG. 1 illustrates a microfabricated measurement system in accordance with a preferred embodiment of the present invention.

The measurement system comprises a substrate chip 2 which includes a main channel 4, in this embodiment a linear channel, which includes an inlet port 6 and an outlet port 8 and defines a separation channel 10 in a central section thereof, a first plasma generator 12 for generating a first plasma P1 upstream of the separation channel 10, a second plasma generator 14 for generating a second plasma P2 downstream of the separation channel 10, and an optical detector 16 for detecting the optical emission of the second plasma P2 generated by the second plasma generator 14. In an alternative embodiment the main channel 4 can be a meandering channel which preferably includes a plurality of bends. Preferably, the main channel 4 has a width of from about 150 to 300 μm, a depth of from about 10 to 40 μm and a length of more than about 50 cm.

The first plasma generator 12 comprises first and second electrode-housing regions 18, 20 connected to the main channel 4 at opposed sides thereof, and first and second conductive electrode members 22, 24, with each of the electrode members 22, 24 comprising an electrode 26, 28 disposed in a respective one of the electrode-housing regions 18, 20, a contact pad 30, 32 for providing a means of contact to an external power supply, and a lead 34, 36 connecting the electrode 26, 28 and the contact pad 30, 32.

The second plasma generator 14 comprises first and second electrode-housing regions 38, 40 connected to the main channel 4 at opposed sides thereof, and first and second conductive electrode members 42, 44, with each of the electrode members 42, 44 comprising an electrode 46, 48 disposed in a respective one of the electrode-housing regions 38, 40, a contact pad 50, 52 for providing a means of contact to an external power supply, and a lead 54, 56 connecting the electrode 46, 48 and the contact pad 50, 52.

Materials suitable for the electrode members 22, 24, 42, 44 include gold and tungsten. In this embodiment the electrodes 26, 28, 46, 48 are spaced from the longitudinal edges of the main channel 4. It will be understood, however, that the electrodes 26, 28, 46, 48 can have any configuration which allow plasmas to be generated therebetween. Further, in this embodiment the electrodes 26, 28, 46, 48 are substantially planar elements which extend over one surface of the respective electrode-housing regions 18, 20, 38, 40. In an alternative embodiment the electrodes 26, 28, 46, 48, in particular that electrode which acts as the cathode, can be hollow. In this modified chip 2, the electrodes 26, 28, 46, 48 are each defined by a conductive layer which extends over substantially all of the surfaces of the respective electrode-housing regions 18, 20, 38, 40.

In this embodiment the plasma generators 12, 14 are configured to be driven by applying a d.c. high voltage across the respective pairs of electrodes 26, 28, 46, 48. In a preferred embodiment inductive or piezoelectric voltage converters are used as the electrical supply to provide the very small average currents at the relatively high voltages required to drive the plasma generators 12, 14. As will be appreciated, such voltage converters are much more compact than the conventional electrical supply arrangement of a high voltage power supply and high impedance resistors.

In this embodiment the optical detector 16 comprises a photodiode which is mounted to the one plate of the chip 2 adjacent the plasma-generation region of the second plasma generator 14. With regard to the optical properties, atomic and/or molecular emissions can be measured, typically the atomic lines or rotation-vibration bands of molecules, for example CH, CN, NH, C2, OH, etc.

The chip 2 is fabricated from two planar substrate plates, in this embodiment composed of microsheet glass. In a first step, one plate is etched by HF wet etching to form wells which define the main channel 4. In a second step, the other plate is etched by HF wet etching to define trenches corresponding in shape to the electrode members 22, 24, 42, 44. In a third step, each of the trenches is filled with a first layer of chromium and a second layer of gold to form the electrode members 22, 24, 42, 44. In a fourth step, two holes are drilled by ultrasonic abrasion into the other plate so as to provide openings defining the inlet and outlet ports 6, 8. In a fifth and final step, the two plates are bonded together by direct fusion bonding so as to form the chip 2. In this embodiment the one plate is of smaller dimension than the other plate such that the contact pads 30, 32, 50, 52 are exposed.

The measurement system further comprises a fluid sample delivery line 58 which includes a metering valve 60 and is connected to the inlet port 6 of the main channel 4, in this embodiment by a Swagelok™ connector to a fused silica capillary tube bonded to the chip 2, through which a controlled flow of a fluid sample, in this embodiment a gaseous sample, is in use introduced. In another embodiment the fluid sample could be a liquid.

The measurement system further comprises a waste line 62 which is connected to the outlet port 8 of the main channel 4, in this embodiment by a Swagelok™ connector to a fused silica capillary tube bonded to the chip 2, through which the gaseous sample is exhausted to waste.

The measurement system further comprises a d.c. high voltage power supply 64 connected to the contact pads 30, 32, 50, 52 of the electrode members 22, 24, 42, 44 of the plasma generators 12, 14.

The measurement system further comprises a computer 66 connected to the optical detector 16, the valve 60 in the fluid sample delivery line 58 and the high voltage supply 64 such as to regulate the flow rate of the fluid sample through the main channel 4, control the operation of the plasma generators 12, 14 and allow for recordal of the optical emission of the second plasma P2 generated by the second plasma generator 14.

Operation of the measurement system is as follows.

In a first step, as illustrated in FIG. 2(a), under the control of the computer 66, the valve 60 in the delivery line 58 is configured to deliver a controlled flow of a gaseous sample into the main channel 4, the first plasma generator 12 is operated at a high power for developing a first plasma P1 sufficient to at least modify the gaseous sample, in this embodiment destroy the gaseous sample by burning, and the second plasma generator 14 is operated at a power for developing a second plasma P2 sufficient to generate emission spectra of the separated components of the gaseous sample as those components pass through the second plasma P2. As illustrated in FIG. 2(b), as the gaseous sample flow passes through the first plasma P1, that sample is destroyed by burning such as to leave only residual components, in this embodiment CO. Prior to the destroyed gaseous sample flow reaching the second plasma P2, the optical detector 16 generates a signal representative only of noise. This detected noise signal is illustrated schematically in FIG. 3. As illustrated in FIG. 2(c), the destroyed gaseous sample then passes through the second plasma P2. When the destroyed gaseous sample passes through the second plasma P2, the optical detector 16 generates a signal representative of the emission from the residual components, in this embodiment the CO emission, of the destroyed gaseous sample. This detected signal, which is substantially invariant with time, is illustrated schematically in FIG. 4.

In a second step, as illustrated in FIG. 2(d), the power supply to the first plasma generator 12 is interrupted, thereby interrupting the first plasma P1.

In a third step, as illustrated in FIG. 2(e), the power supply to the first plasma generator 12 is restored after the elapse of a predetermined period of time, thereby restoring the first plasma P1 and destroying the subsequent gaseous sample passing therethrough. During the period in which the first plasma P1 is interrupted, a volume of the gaseous sample passes as a sample plug 70 into the separation channel 10 without any modification; the volume of the sample plug 70 being determined by the time period during which the first plasma P1 is interrupted. As illustrated in FIG. 2(f), with the first plasma P1 being maintained, the components C1, C2, C3 of the sample plug 70 then separate on transit through the separation channel 10. These separated components C1, C2, C3 then pass through the second plasma P2, and the optical emission generated on each of the components C1, C2, C3 passing through the second plasma P2 is detected by the optical detector 16. This detected signal is illustrated diagrammatically in FIG. 5.

FIG. 6 illustrates a number of detected spectral emissions varying with time in a manner showing the separation of various components of the material flowing through the channel.

Finally, it will be understood that the present invention has been described in its preferred embodiments and can be modified in many different ways without departing from the scope of the invention as defined by the appended claims.

In one alternative embodiment the first plasma generator 12 can, instead of being switched off to interrupt the generation of the first plasma P1, be switched to a low power level at which the fluid sample is substantially unaffected. In this way, the delay in the ignition of the first plasma generator 12 can be avoided.

In another alternative embodiment the chip 2 can include a plurality of plasma generators 12 upstream of the separation channel 10. The use of a plurality of plasma generators 12 allows for the modification of the fluid sample where a single plasma generator 12 alone could not achieve the necessary modification because, for example, of a power constraint on each plasma generator 12. The use of a plurality of plasma generators 12 which operate under different operating conditions, where spaced a predetermined distance apart, also allows for a plurality of different sample plugs to be provided in unison, the components of which plugs are separated in the separation column 10 and the signals detected by the optical detector 16 can be deconvolved. The use of a plurality of, typically two, plasma generators 12 further allows for the plasma generators 12 to be switched on and off consecutively, thereby obviating any problem of slow decay times.

1. A sampling system for providing a volume, as a sample plug, from a flow of a fluid sample, comprising:
a flow channel through which a flow of a fluid sample is in use passed;
a plasma generator for generating a plasma in the flow channel; and
a control unit operably configured to drive the plasma generator at a power level at which the fluid sample passing therethrough is modified by the plasma and interrupt the plasma for a predeterminable period of time such as to allow a sample plug of the fluid sample to pass downstream thereof.

2. The sampling system of claim 1, wherein the control unit is configured to switch the plasma generator between a first power level at which the fluid sample is modified by the plasma and a second, lower power level.

3. The sampling system of claim 2, wherein the fluid sample is substantially unmodified by the plasma at the second power level.

4. The sampling system of claim 3, wherein the second power level is a zero power level at which the plasma generator is switched off.

5. The sampling system of any of claims 1 to 4, wherein the control unit is configured to drive the plasma generator at a power at which the fluid sample is destroyed by the plasma.

6. The sampling system of any of claims 1 to 5, wherein the plasma generator includes first and second electrodes across which a voltage is applied to generate the plasma.

7. The sampling system of any of claims 1 to 6, wherein the flow channel is a substantially linear channel or a meandering channel which preferably includes a plurality of bends.

8. The sampling system of any of claims 1 to 7, wherein the fluid sample is a gaseous sample.

9. The sampling system of any of claims 1 to 8, further comprising at least one further plasma generator upstream of the first-mentioned plasma generator, and wherein the control unit is operably configured to drive each of the plasma generators at a power level at which the fluid sample passing therethrough is modified by the respective plasma and interrupt the respective plasma for a predeterminable period of time.

10. The sampling system of any of claims 1 to 9, wherein the sampling system further comprises a substrate chip in which the flow channel and the or each plasma generator are defined.

11. A measurement system comprising the sampling system of any of claims 1 to 10.

12. The measurement system of claim 11, wherein the flow channel defines a separation channel downstream of the plasma generator in which the components of the sample plug are in use separated, and further comprising a detector downstream of the separation channel for detecting the separated components of the sample plug.

13. The measurement system of claim 12, wherein the detector comprises a plasma generator for generating a detection plasma in the flow channel downstream of the separation channel and an optical sensor for detecting the optical emission of the detection plasma.

14. A method of providing a volume, as a sample plug, from a flow of a fluid sample, comprising the steps of:
providing a sampling system comprising a flow channel and a plasma generator for generating a plasma in the flow channel;
passing a flow of a fluid sample through the flow channel;
generating a plasma in the flow channel at a power level to modify the fluid sample passing therethrough; and
interrupting the plasma for a predeterminable period of time such as to allow a sample plug of the fluid sample to pass downstream thereof.

15. The method of claim 14, wherein the step of interrupting the plasma comprises the step of switching the plasma generator to a second, lower power level.

16. The method of claim 15, wherein the fluid sample is substantially unmodified by the plasma at the second power level.

17. The method of claim 16, wherein the second power level is a zero power level at which the plasma generator is switched off.

18. The method of any of claims 14 to 17, wherein the fluid sample is destroyed by the plasma at the first power level.

19. The method of any of claims 14 to 18, wherein the plasma generator includes first and second electrodes across which a voltage is applied to generate the plasma.

20. The method of any of claims 14 to 19, wherein the flow channel is a substantially linear channel or a meandering channel which preferably includes a plurality of bends.

21. The method of any of claims 14 to 20, wherein the fluid sample is a gaseous sample.

22. The method of any of claims 14 to 21, further comprising the step of generating at least one further plasma upstream of the first-mentioned plasma at a power level to modify the fluid sample passing therethrough, and wherein the step of interrupting the plasma comprises the step of interrupting each of the respective plasmas for a predeterminable period of time.

23. The method of any of claims 14 to 22, wherein the sampling system further comprises a substrate chip in which the flow channel and the or each plasma generator are defined.
